(19) United States
(12) Patent Application Publication
(10) Pub. No.: US 2022/0266708 A1
(43) Pub. Date: Aug. 25, 2022

(54) PARKING ASSIST DEVICE, PARKING ASSIST METHOD, AND RECORDING MEDIUM

(71) Applicant: PANASONIC INTELLECTUAL PROPERTY MANAGEMENT CO., LTD., Osaka (JP)

(72) Inventors: Yukio SAKAI, Osaka Fu (JP); Shota AKAURA, Kanagawa Ken (JP)

(73) Assignee: PANASONIC INTELLECTUAL PROPERTY MANAGEMENT CO., LTD., Osaka (JP)

(21) Appl. No.: 17/742,139

(22) Filed: May 11, 2022

Related U.S. Application Data
(63) Continuation of application No. PCT/JP2020/027560, filed on Jul. 15, 2020.

(30) Foreign Application Priority Data
Nov. 15, 2019 (JP) 2019-207222

(51) Int. Cl. B60L 53/38; B60L 53/12; B60L 53/36; G01C 21/36; H02J 50/10; H02J 50/80; H02J 50/90; H02J 50/40

(52) U.S. Cl. CPC B60L 53/38; B60L 53/12; B60L 53/36; G01C 21/3647; H02J 50/10; H02J 50/80; H02J 50/90; H02J 50/402; B60W 30/06

(57) ABSTRACT

A parking assist device is used for a vehicle on which a power receiving coil including a first coil and a second coil is mounted. The parking assist device includes a hardware processor functioning as an acquisition unit and a vehicle control unit. The acquisition unit serves to acquire route information for parking the vehicle at a facing position where a power feeding coil and the first coil of the power receiving coil face each other. The vehicle control unit serves to perform control of parking the vehicle by using the route information. The power receiving coil is mounted on the vehicle such that a distance between a center position of the first coil and a center position of the vehicle in a vehicle length direction becomes shorter than a distance between a center position of the second coil and the center position of the vehicle.

### CROSS-REFERENCE TO RELATED APPLICATIONS

This application is national stage application of International Application No. PCT/JP2020/027560, filed Jul. 15, 2020, which designates the United States, incorporated herein by reference, and which claims the benefit of priority from Japanese Patent Application No. 2019-207222, filed Nov. 15, 2019, the entire contents of which are incorporated herein by reference.

### FIELD

The present disclosure relates generally to a parking assist device, a parking assist method, and a recording medium.

### BACKGROUND

There is a technology of performing contactless charging on an electrical storage device included in an electrically-operated vehicle such as a hybrid automobile and an electrical automobile. In contactless charging, a vehicle is required to be parked in such a manner that a power receiving coil of the vehicle side and a power feeding coil installed in a parking space or the like are aligned.

It has been therefore known a technology of performing alignment of a power receiving coil and a power feeding coil by using a parking assist device (for example, Japanese Patent No. 6350312 B2). The parking assist device calculates a route for parking a vehicle in a parking region provided in a parking space on the basis of the relative position of the vehicle to the parking region.

### SUMMARY

A parking assist device according to one aspect of the present disclosure is used for a vehicle on which a power receiving coil including a first coil and a second coil is mounted. The parking assist device includes a hardware processor connected to a memory and configured to function as an acquisition unit and a vehicle control unit. The acquisition unit serves to acquire route information for parking the vehicle at a facing position where a power feeding coil installed in a parking region and the power receiving coil included in the vehicle face each other. The vehicle control unit serves to perform control of parking the vehicle on the basis of the route information. The power receiving coil is mounted on the vehicle in such a manner that a distance between a center position of the first coil and a center position of the vehicle in a vehicle length direction becomes shorter than a distance between a center position of the second coil and the center position of the vehicle in the vehicle length direction. The facing position is a position where the power feeding coil and the first coil of the power receiving coil face each other.

### BRIEF DESCRIPTION OF DRAWINGS

FIG. 1 is a schematic diagram illustrating an example of a configuration of a contactless charging system according to a first embodiment;

FIG. 2 is a block diagram illustrating an example of a configuration of a vehicle according to the first embodiment;

FIG. 3 is a block diagram illustrating an example of a hardware configuration of a parking assist device according to the first embodiment;

FIGS. 4A and 4B are each a schematic diagram illustrating a parking operation of the vehicle according to the first embodiment;

FIG. 5 is a flowchart illustrating an example of a procedure of parking assist processing to be executed by the parking assist device according to the first embodiment;

FIG. 6 is a block diagram illustrating an example of a configuration of a vehicle and a parking assist device according to a modification example of the first embodiment;

FIG. 7 is a block diagram illustrating an example of a configuration of a vehicle according to a second embodiment; and

FIG. 8 is a flowchart illustrating an example of a procedure of parking assist processing to be executed by a parking assist device according to the second embodiment.

### DETAILED DESCRIPTION

Hereinafter, embodiments of a parking assist device, a parking assist method, and a recording medium according to the present disclosure will be described with reference to the drawings.

### First Embodiment

Hereinafter, a first embodiment will be described in detail with reference to the drawings.

### Configuration Example of Contactless Charging System

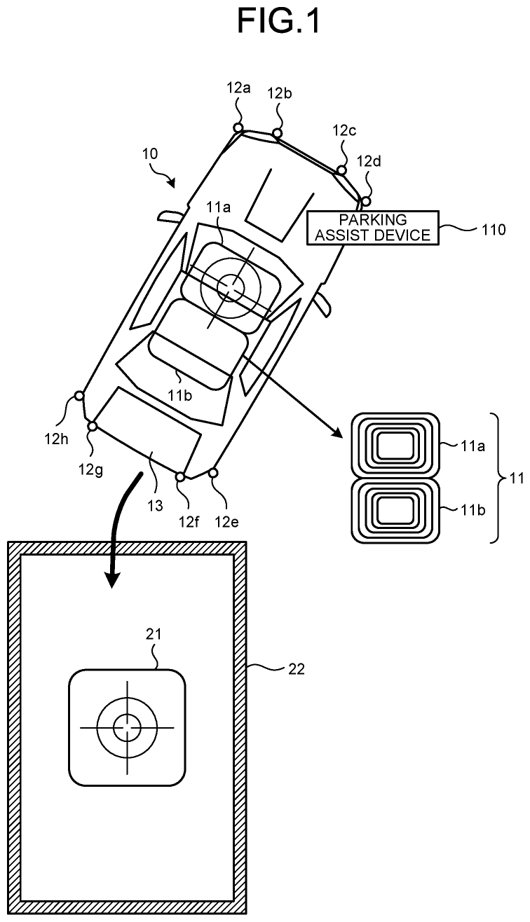

FIG. 1 is a schematic diagram illustrating an example of a configuration of a contactless charging system according to the first embodiment. As illustrated in FIG. 1, the contactless charging system of the first embodiment includes a parking assist device 110, detection units 12a to 12h, a power receiving coil 11, an electrical storage device 13, a power feeding coil 21, and a parking region 22.

The parking assist device 110 is mounted on a vehicle 10, for example. A detailed configuration of the parking assist device 110 will be described later.

The detection units 12a to 12h are at least any of, for example, cameras, sonars, a Global Navigation Satellite System (GNSS) receivers, other sensors, and the like, and are attached to the front, rear, left, and right sides and the like of the vehicle 10, for example. The cameras are visible light cameras, CCD cameras being capable of detecting light in a wider wavelength band, CMOS cameras, or the like. The sonars may be ultrasonic sonars that emit ultrasonic waves, or the like. The GNSS receivers perform position information measurement by receiving radio waves from GNSS satellites. Other sensors include, for example, a millimeterwave radar, a Light Detection and Ranging, Laser Imaging Detection and Ranging (LiDAR), and the like. With at least any of the above-described configurations, the detection units 12a to 12h generate detection signals including at least any of position information of the vehicle 10, position information of the parking region 22 to be described later, and external appearance information and position information of the power feeding coil 21.

The power receiving coil 11 is formed as, for example, a double-D (DD)-type coil including a first coil 11a and a second coil 11b, and is mounted near a body lower side of the vehicle 10 that faces the ground surface. The power receiving coil 11 is connected to the electrical storage device 13 and transmits, to the electrical storage device 13, power received from the power feeding coil 21 by the principle of electromagnetic induction. The electrical storage device 13 is thereby charged.

Note that the double-D type coil may be formed from a single wire. The double-D type coil is obtained by that the single wire forms, on the same plane, a first multiwinding loop or coil and a second multiwinding loop or coil. As an example, the wire of the first multiwinding loop or coil is wound from the inside toward the outside of the first multiwinding loop or coil. Continuously to the wire located at the outside of the first multiwinding loop or coil, the wire of the second multiwinding loop or coil is wound from the outside toward the inside of the second multiwinding loop or coil.

The first coil 11a is disposed near a center position of the vehicle 10 in a front-back direction, and the second coil 11b is disposed on the rear side of the vehicle 10 adjacently to the first coil 11a. The front-back direction of the vehicle 10 refers to a vehicle length direction of the vehicle 10. In addition, the front side of the vehicle 10 is the end of a vehicle length located in the travelling direction of the vehicle 10 when the vehicle 10 is normally running, that is, when a gear has been set to drive. In addition, the rear side of the vehicle 10 is the end of the vehicle length located in the opposite direction to the travelling direction of the vehicle 10 when the vehicle 10 is normally running. A distance between a center position of the first coil 11a and a center position of the vehicle 10 in the front-back direction is, for example, shorter than a distance between a center position of the second coil 11b and the center position of the vehicle 10 in the front-back direction. In other words, a distance between the center position of the first coil 11a and a front end being an end of the vehicle 10 closest from the center position is, for example, longer than a distance between the center position of the second coil 11b and a rear end being an end of the vehicle 10 closest from the center position. Note that the first coil 11a may be disposed near the center position of the vehicle 10 in the front-back direction, and the second coil 11b may be disposed on the front side of the vehicle 10 adjacently to the first coil 11a.

The power feeding coil 21 is configured to perform contactless power feeding to the power receiving coil 11 by being installed on the ground surface within the parking region 22 and by that the power receiving coil 11 is placed at a position facing the power feeding coil 21. In other words, current flows in the power feeding coil 21, and a magnetic flux is generated in a direction vertical to the ground surface. In this state, when the power receiving coil 11 is placed to face the power feeding coil 21, the magnetic flux of the power feeding coil 21 passes through the inside of the power receiving coil 11, and thereby current is generated in the power receiving coil 11. At this time, when either coil 11a or 11b of the power receiving coil 11 is placed at a position directly above the power feeding coil 21, the bonding of a magnetic field enters an optimum state, and the charging efficiency becomes the maximum or becomes a value close to the maximum.

As in the above, the adjustment of the positions of the power receiving coil 11 and the power feeding coil 21 in such a manner that the power receiving coil 11 can receive power feeding from the power feeding coil 21 will be referred to as alignment of the power receiving coil 11 and the power feeding coil 21. By the alignment of the power receiving coil 11 and the power feeding coil 21, the power receiving coil 11 and the power feeding coil 21 get close enough to each other, and contactless charging is enabled between the power receiving coil 11 and the power feeding coil 21.

The parking region 22 serves as a goal when the vehicle 10 is parked by using the parking assist device 110. As described later, the parking assist device 110 recognizes the parking region 22 and parks the vehicle 10 in the parking region 22 as the goal.

### Configuration Example of Vehicle

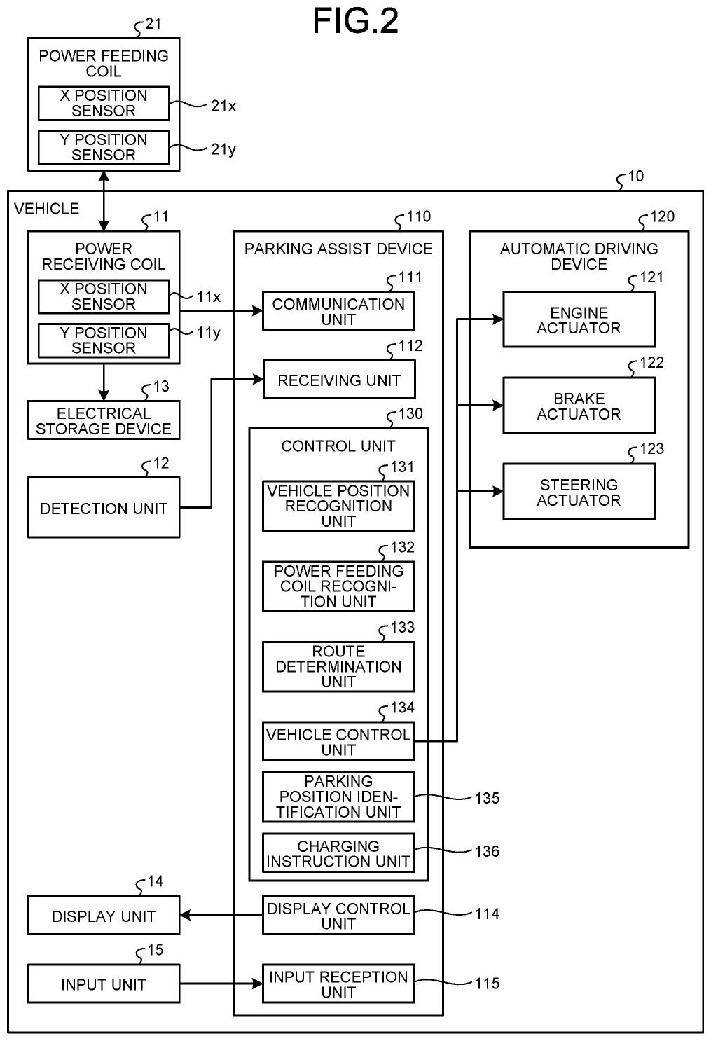

Next, a configuration example of the vehicle 10 of the first embodiment will be described with referring to FIG. 2. FIG. 2 is a block diagram illustrating an example of a configuration of the vehicle 10 according to the first embodiment. The vehicle 10 is configured as an electrically-operated vehicle such as a hybrid automobile or an electrical automobile, and obtains power for running by power supply from the outside. In addition, the vehicle 10 is configured as a vehicle capable of performing automatic parking though parking assist (hereinafter, such a vehicle will be referred to as an automatic parking vehicle).

As illustrated in FIG. 2, the vehicle 10 of the first embodiment includes the power receiving coil 11, the detection units 12, the electrical storage device 13, a display unit 14, an input unit 15, the parking assist device 110, and an automatic driving device 120.

The power receiving coil 11 includes a plurality of X position sensors 11x indicating positions in an X direction of the power receiving coil 11, and a plurality of Y position sensors 11y indicating positions in a Y direction of the power receiving coil 11. The X direction of the power receiving coil 11 is a direction extending along a vehicle width of the vehicle 10, and the Y direction of the power receiving coil 11 is a direction extending along a vehicle length of the vehicle 10. The power feeding coil 21 installed within the parking region 22 includes a plurality of X position sensors 21x indicating positions in the X direction of the power feeding coil 21, and a plurality of Y position sensors 21y indicating positions in the Y direction of the power feeding coil 21. The X direction of the power feeding coil 21 is a direction extending along a width in a shorter direction of the parking region, and the Y direction of the power feeding coil 21 is a direction extending along a width in a longer direction of the parking region.

When the power receiving coil 11 and the power feeding coil 21 get close to each other, signals are exchanged between their X position sensors 11x and 21x and between their Y position sensors 11y and 21y. Signals transmitted and received between the X position sensors 11x and 21x and signals transmitted and received between the Y position sensors 11y and 21y are different in frequency. In addition, when distances between the X position sensors 11x and 21x get close to each other and distances between the Y position sensors 11y and 21y get close to each other, signal intensity, that is, resolution of signal (Signal to Noise) increases. From these actions, a distance in the X direction and a distance in the Y direction between the power receiving coil 11 and the power feeding coil 21 can each be acquired. In addition, an overlap degree between the first coil 11a of the power receiving coil 11 and the power feeding coil 21 and an overlap degree of the second coil 11b of the power receiving coil 11 and the power feeding coil 21 can each be acquired.

The configurations of the detection units 12 (12a to 12h) are described above.

The display unit 14 is a display device such as a liquid crystal monitor. The input unit 15 is, for example, a touch-type panel to which instruction information or the like is input from a driver.

The parking assist device 110 includes a communication unit 111, a receiving unit 112, a display control unit 114, an input reception unit 115, and a control unit 130.

The communication unit 111 receives, from the power receiving coil 11, signals exchanged between the X position sensors 11x and 21x and signals exchanged between the Y position sensors 11y and 21y. The communication unit 111 transmits the received signals to the control unit 130.

The receiving unit 112 receives detection signals from the detection units 12. The detection signals include, for example, pieces of information indicating the position of the vehicle 10, the position of the parking region 22, and the external appearance and the position of the power feeding coil 21. The receiving unit 112 transmits the received detection signals to the control unit 130.

In accordance with a command from the control unit 130, the display control unit 114 controls the display unit 14 to display various pictures relating to parking assist. The input reception unit 115 receives instruction information or the like that has been input from the input unit 15, and transmits the received instruction information or the like to the control unit 130.

The control unit 130 includes a vehicle position recognition unit 131, a power feeding coil recognition unit 132, a route determination unit 133, a vehicle control unit 134, a parking position identification unit 135, and a charging instruction unit 136. The route determination unit 133 is an example of the acquisition unit configured to acquire route information for parking the vehicle 10 at a facing position where the power feeding coil 21 and the power receiving coil 11 face each other.

The vehicle position recognition unit 131 receives detection signals from the detection units 12 via the receiving unit 112. The vehicle position recognition unit 131 recognizes a relative position of the vehicle 10 to the parking region 22 and the power feeding coil 21, on the basis of the received detection signals. More specifically, for example, the vehicle position recognition unit 131 performs image recognition processing on an image from a camera and recognizes positions of the parking region 22 and the power feeding coil 21. Note that the camera may perform image recognition processing on an image captured by the camera and recognize positions of the parking region 22 and the power feeding coil 21, and then the vehicle position recognition unit 131 may receive position information of the parking region 22 and the power feeding coil 21 from the camera. In addition, the vehicle position recognition unit 131 recognizes distances to the parking region 22 and the power feeding coil 21, on the basis of, for example, an ultrasonic wave signal and a reflected wave signal from an ultrasonic sonar. In addition, the vehicle position recognition unit 131 recognizes a current position of the vehicle 10 on the basis of, for example, position information from a GNSS receiver.

The power feeding coil recognition unit 132 recognizes the type of the power feeding coil 21 on the basis of the received detection signal. Examples of types of the power feeding coil 21 include a DD-type coil, a circular (CR)-type coil containing a single coil, and the like. The power feeding coil recognition unit 132 performs image recognition processing on an image received from a camera and recognizes the type of the power feeding coil 21 on the basis of the external appearance of the power feeding coil 21.

Nevertheless, a method of recognizing the type of the power feeding coil 21 is not limited to the above. For example, the power feeding coil 21 may transmit a signal indicating the type of itself, and then the power feeding coil recognition unit 132 may receive the signal. Alternatively, a parking area for a contactless charging system may include a server, and the power feeding coil recognition unit 132 may receive from the server a signal indicating the type of the power feeding coil 21.

The route determination unit 133 calculates a route for parking the vehicle 10 within the parking region 22 on the basis of: the relative position of the vehicle 10 to the parking region 22 and the power feeding coil 21 that has been recognized by the vehicle position recognition unit 131, and the type of the power feeding coil 21 that has been recognized by the power feeding coil recognition unit 132.

Note that the power feeding coil 21 is a CR-type coil and thus different in type from the power receiving coil 11 being a DD-type coil. In this case, the route determination unit 133 calculates a route for a parking position where the first coil 11a or the second coil 11b, whose center position is located closer to a center position of the vehicle 10 in the front-back direction, is positioned above the center position of the power feeding coil 21. In short, in the above-described example, the route determination unit 133 calculates a route in such a manner that the center position of the first coil 11a is positioned above the center position of the power feeding coil 21. Note that it is not necessary to strictly align the center position of the first coil 11a and the center position of the power feeding coil 21. For example, in a case where charging efficiency becomes the maximum at a position deviating from the center position of the first coil 11a toward adjacent sides of the first coil 11a and the second coil 11b, a route may be calculated such that the position deviating from the center position of the first coil 11a toward the adjacent sides is positioned above the center position of the power feeding coil 21.

Hereinafter, the above-described positional relationship between the power feeding coil 21 and the power receiving coil 11 will be referred to as a facing position. More specifically, the facing position is a position where the center position of the power feeding coil 21 and the center position of the first coil 11a of the power receiving coil 11 face each other. Alternatively, the facing position is a position where the center position of the power feeding coil 21 and a position deviating from the center position of the first coil 11a toward the side adjacent to the second coil 11b face each other.

Note that, when the power feeding coil is the DD-type coil which is the same as the power receiving coil 11, the route determination unit 133 calculates a route for a parking position such that the center positions of the two coils 11a and 11b of the power receiving coil 11 and the center positions of two coils of the power feeding coil are respectively aligned.

The vehicle control unit 134 automatically parks the vehicle 10 at a predetermined position by controlling an engine actuator 121, a brake actuator 122, and a steering actuator 123, which will be described later, on the basis of the parking route calculated by the route determination unit 133.

After the vehicle control unit 134 parks the vehicle 10 in accordance with the parking route, the parking position identification unit 135 identifies a parking position of the vehicle 10. For identifying a parking position of the vehicle 10, the parking position identification unit 135 calculates a positional shift amount between the power receiving coil 11 and the power feeding coil 21 on the basis of a signal received from the power receiving coil 11 via the communication unit 111.

The positional shift amount between the power receiving coil 11 and the power feeding coil 21 can be defined as follows. For example, a position directly above the center position of the power feeding coil 21 is set as a reference position. Then, it is assumed that the directly-above position serving as the reference position is located at a height where the power receiving coil 11 is positioned. A shift amount from such a reference position to the center position of the power receiving coil 11 is the positional shift amount between the power receiving coil 11 and the power feeding coil 21. More specifically, the positional shift amount between the power receiving coil 11 and the power feeding coil 21 is represented as shift amounts in the X direction and the Y direction of the center position of the power receiving coil 11 from the above-described reference position. For example, in a case where the center position of the power receiving coil 11 and the center position of the power feeding coil 21 completely overlap with each other in an up-down direction, the positional shift amount between the power receiving coil 11 and the power feeding coil 21 becomes 0 mm in the X direction and 0 mm in the Y direction.

In the case of performing contactless charging, an allowable range of the positional shift amount between the power receiving coil 11 and the power feeding coil 21 is set to, for example, 100 mm or less as a positional shift amount in the X direction and 75 mm or less as a positional shift amount in the Y direction. In other words, the allowable range of the positional shift amount between the power receiving coil 11 and the power feeding coil 21 refers to, for example, a range within which charging efficiency of 80% or more can be obtained, and more preferably, a range within which charging efficiency of 85% or more can be obtained.

When the parking position identification unit 135 identifies the parking position of the vehicle 10, the charging instruction unit 136 waits for the vehicle 10 to enter a predetermined state and then causes the power receiving coil 11 to start power receiving from the power feeding coil 21. The charging of the electrical storage device 13 is thereby started via the power receiving coil 11.

The predetermined state of the vehicle 10 refers to, for example, a state that an engine of the vehicle 10 stops, and a predetermined time has elapsed from the engine stop. After the engine of the vehicle 10 stops, a driver or the like can thereby evacuate from the periphery of the vehicle 10 before charging is started. Accordingly, the influence of a leakage magnetic field on the driver or the like can be suppressed.

In addition, a biosensor may be provided in the vehicle 10. Then, in a case where the bio sensor does not detect the existence of a human or an animal inside or near the vehicle 10, the power receiving coil 11 may be caused to start power receiving from the power feeding coil 21.

When power of a predetermined amount is stored into the electrical storage device 13, the charging instruction unit 136 causes the power receiving coil 11 to end power receiving from the power feeding coil 21.

The vehicle 10 may include a notification device that gives, to the electrical storage device 13, notification that charging is ongoing. The notification device may be a lamp provided with an indication indicating that charging is ongoing and may give notification that charging is ongoing by lighting up the lamp. Alternatively, the notification device may be obtained by diverting a lamp or a light originally included in the vehicle 10, such as a parking lamp, and may notify that charging is ongoing, by blinking the lamp or the light.

The automatic driving device 120 includes the engine actuator 121, the brake actuator 122, and the steering actuator 123.

The engine actuator 121 adjusts supply amounts of fuel and air to be supplied to an engine, on the basis of an output of the vehicle control unit 134. The brake actuator 122 adjusts braking force of wheels included in the vehicle 10, on the basis of an output of the vehicle control unit 134. The steering actuator 123 adjusts a steering angle of the vehicle 10 on the basis of an output of the vehicle control unit 134.

### Hardware Configuration Example of Parking Assist Device

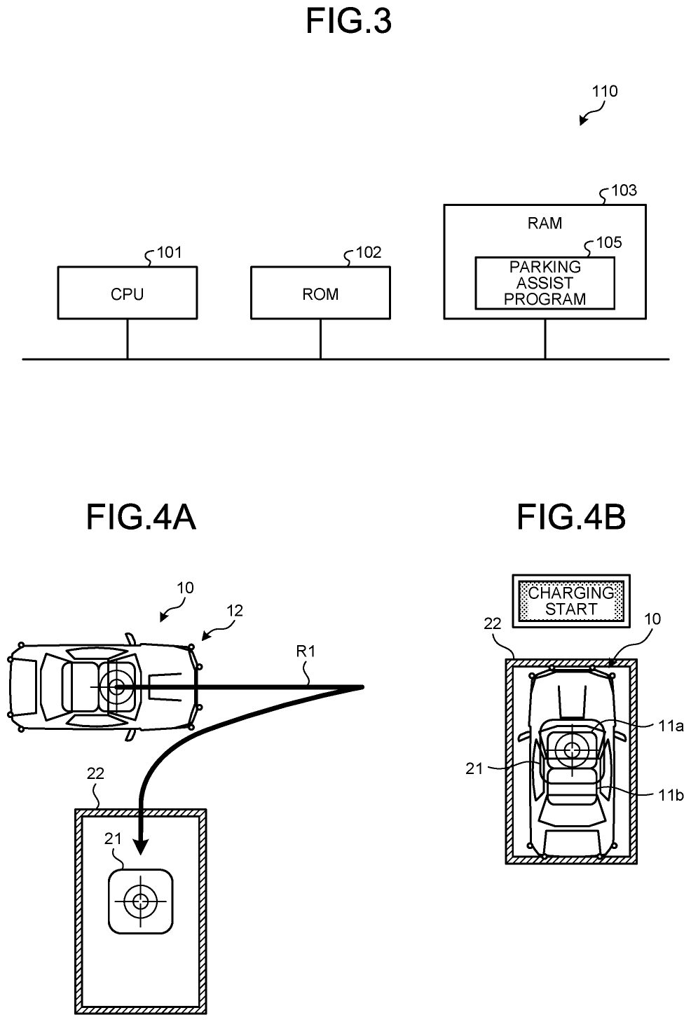

Next, a hardware configuration example of the parking assist device 110 of the first embodiment will be described with referring to FIG. 3. The parking assist device 110 is configured as a computer including, for example, a Central Processing Unit (CPU), a Random Access Memory (RAM), and a storage device.

FIG. 3 is a block diagram illustrating an example of a hardware configuration of the parking assist device 110 according to the first embodiment. As illustrated in FIG. 3, the parking assist device 110 includes CPU 101, and a Read Only Memory (ROM) 102 and a RAM 103 serving as storage devices. In the parking assist device 110, the CPU 101, the ROM 102, and the RAM 103 are connected by a bus line.

The CPU 101 (an example of the hardware processor) performs parking assist of the vehicle 10 by using a parking assist program 105 being a computer program. The parking assist program 105 includes a plurality of computer-executable commands for performing parking assist. The parking assist program 105 may be provided by a computer program product including a computer-readable recording medium on which the plurality of computer-executable commands for performing parking assist is stored. In the parking assist program 105, the plurality of commands causes the computer to execute parking assist processing.

The parking assist program 105 may be stored in the ROM 102 and loaded onto the RAM 103 via the bus line. In FIG. 3, a state where the parking assist program 105 has been loaded on the RAM 103 is illustrated. Aside from this, the ROM 102 stores various parameters necessary for parking assist processing, and various types of information such as the type of the power receiving coil 11 mounted on the vehicle 10.

The CPU 101 executes the parking assist program 105 loaded onto the RAM 103. Specifically, in the parking assist device 110, the CPU 101 reads out the parking assist program 105 from the ROM 102, loads the parking assist program 105 onto a program storage region in the RAM 103, and executes various types of parking assist processing. The CPU 101 causes the RAM 103 to temporarily store, in a data storage region formed in the RAM 103, various types of data generated in the various types of parking assist processing.

The parking assist program 105 executed in the parking assist device 110 has a configuration of modules, and those modules are loaded onto a main storage device and generated on the main storage device.

In addition, the parking assist program 105 can be recorded onto a non-transitory recording medium in a computer-readable state. Examples of such a computer-readable recording media on which the parking assist program 105 is recorded include a flexible disk, a hard disk, a CD-ROM, an MO, a DVD, a DVD-ROM, a DVD-RAM, a Blu-ray Disc (BD (registered trademark)), a semiconductor memory, and the like.

Part of or all the processing of each functional block of the above-described parking assist device 110 may be implemented by a computer program. In addition, each piece of processing of the parking assist device 110 may be implemented by hardware, or may be implemented by software to be implemented together with an operating system, middleware, or a predetermined library. Moreover, the processing may be implemented as mixed processing of software and hardware.

Example of Parking of Vehicle Next, an example of parking the vehicle 10 with support from the parking assist device 110 will be described with referring to FIGS. 4A and 4B. FIGS. 4A and 4B are each a schematic diagram illustrating a parking operation of the vehicle 10 according to the first embodiment.

As illustrated in FIGS. 4A and 4B, the vehicle 10 is automatically parked by using the parking assist device 110 when the vehicle 10 is located at a position where the parking region 22 with the power feeding coil 21 is nearby and where the detection units 12 can detect the parking region 22 and the power feeding coil 21.

FIG. 4A illustrates an example that the position of the vehicle 10 is recognized and a parking route is calculated.

The detection unit 12 generates a detection signal including pieces of position information about the vehicle 10, the parking region 22, and the power feeding coil 21, and a piece of external appearance information of the power feeding coil 21. The detection signal including these pieces of information is received by the receiving unit 112 of the parking assist device 110.

The vehicle position recognition unit 131 included in the control unit 130 of the parking assist device 110 recognizes a relative position of the vehicle 10 to the parking region 22 and the power feeding coil 21, on the basis of the detection signal received by the receiving unit 112 from the detection unit 12.

The power feeding coil recognition unit 132 recognizes the power feeding coil 21 as a CR-type coil on the basis of the detection signal received by the receiving unit 112 from the detection unit 12.

The route determination unit 133 calculates a route from the current position of the vehicle 10 to a target parking position on the basis of information indicating the relative position of the vehicle 10 to the parking region 22 and the power feeding coil 21 that has been given by the vehicle position recognition unit 131, and type information of the power feeding coil 21 that has been given by the power feeding coil recognition unit 132. The calculated route R1 is shown in FIG. 4A.

Note that the power feeding coil 21 is a CR-type coil, so that the route R1 has been calculated to enable the vehicle 10 to be parked in such a manner that the first coil 11a of the power receiving coil 11 is positioned at a facing position to the power feeding coil 21.

FIG. 4B illustrates an example that the vehicle 10 is parked in accordance with the route and charging is started.

The vehicle control unit 134 controls the engine actuator 121, the brake actuator 122, and the steering actuator 123 of the automatic driving device 120 in accordance with the route R1 calculated by the route determination unit 133 to park the vehicle 10 at the target parking position.

When the power feeding coil 21 gets close into a short distance in accordance with the movement of the vehicle 10 that follows the route R1, the power receiving coil 11 included in the vehicle 10 exchanges signals with the power feeding coil 21. More specifically, the X position sensors 11x of the power receiving coil 11 and the X position sensors 21x of the power feeding coil 21 perform transmission and reception of signals for announcing the positions in the X direction of the coils to each other. In addition, the Y position sensors 11y of the power receiving coil 11 and the Y position sensors 21y of the power feeding coil 21 perform transmission and reception of signals for announcing the positions in the Y direction of the coils to each other. These signals are received by the receiving unit 112 of the parking assist device 110.

When the vehicle 10 is parked within the parking region 22, the parking position identification unit 135 calculates distances between the power receiving coil 11 and the power feeding coil 21 in the X direction and the Y direction on the basis of signals from the power receiving coil 11 at the parking position of the vehicle 10. In addition, the parking position identification unit 135 calculates, from the calculated distances, a positional shift amount in the X direction and a positional shift amount in the Y direction between the power receiving coil 11 and the power feeding coil 21. In the example illustrated in FIG. 4B, positional shift amounts in the X direction and the Y direction both fall within the allowable range.

When the parking of the vehicle 10 is completed, the charging instruction unit 136 waits for the vehicle 10 to enter a state of being ready to start charging. The charging instruction unit 136 does not permit the power receiving coil 11 to start charging until the vehicle 10 enters a state of being ready to start charging. Specifically, the charging instruction unit 136 does not permit a charging start until, for example, a predetermined time elapses from a time of an engine stop of the vehicle 10.

When the state of the vehicle 10 becomes a state of being ready to start charging, the charging instruction unit 136 causes the power receiving coil 11 to start charging. At this time, the vehicle 10 may give, to surroundings by using the notification device, notification that charging is ongoing.

### Example of Parking Assist Processing

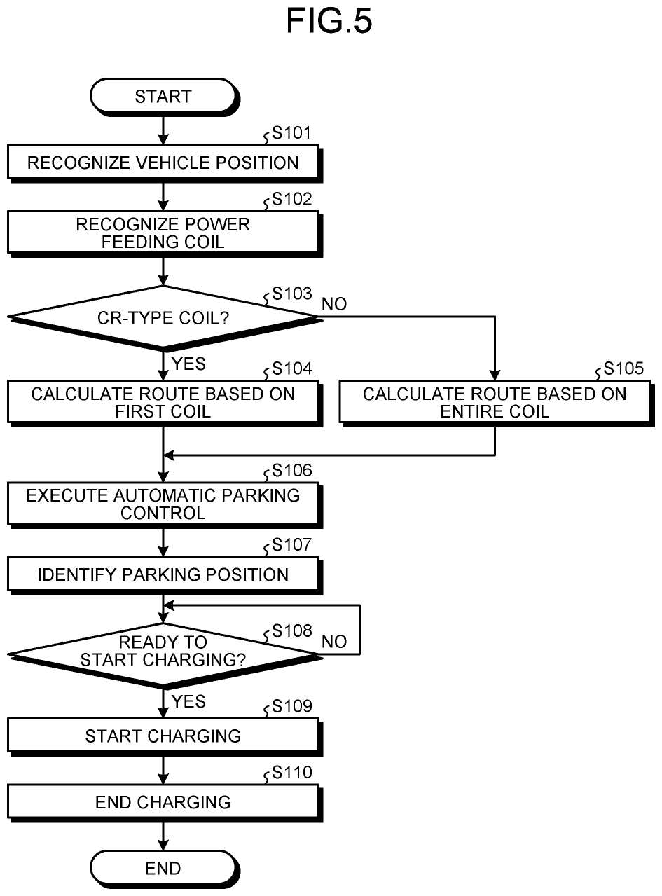

Next, an example of parking assist processing to be executed by the parking assist device 110 of the first embodiment will be described with referring to FIG. 5. FIG. 5 is a flowchart illustrating an example of a procedure of parking assist processing to be executed by the parking assist device 110 according to the first embodiment.

As illustrated in FIG. 5, the vehicle position recognition unit 131 recognizes a relative position of the vehicle 10 to the parking region 22 and the power feeding coil 21 on the basis of detection signals from the detection units 12 (Step S101). The power feeding coil recognition unit 132 recognizes the type of the power feeding coil 21 (Step S102).

The power feeding coil recognition unit 132 determines whether the power feeding coil 21 is a CR-type coil or not (Step S103).

The route determination unit 133 calculates a route for parking the vehicle 10 at an appropriate position in the parking region 22 on the basis of the relative position of the vehicle 10 to the parking region 22 and the power feeding coil 21 (Steps S104 and S105).

Specifically, in a case where the power feeding coil 21 is a CR-type coil (Step S103: Yes), the route determination unit 133 calculates a route in such a manner that the first coil 11a of the power receiving coil 11 is positioned at a facing position to the power feeding coil 21 (Step S104).

On the other hand, in a case where the power feeding coil 21 is a DD-type coil (Step S103: No), the route determination unit 133 calculates a route in such a manner that an overall position of the power receiving coil 11 is positioned at a facing position to the power feeding coil 21 (Step S105).

The vehicle control unit 134 controls the engine actuator 121, the brake actuator 122, and the steering actuator 123 in accordance with the calculated route, and parks the vehicle 10 at a target parking position (Step S106).

The parking position identification unit 135 identifies a parking position of the vehicle 10 by using a relative position in the X direction and a relative position in the Y direction between the power receiving coil 11 and the power feeding coil 21, which are based on signals from the power receiving coil 11 (Step S107).

The charging instruction unit 136 determines whether a predetermined time has elapsed from an engine stop of the vehicle 10 and then the vehicle 10 enters a state of being ready to start charging (Step S108). The charging instruction unit 136 does not permit a charging start until the predetermined time elapses from the engine stop (Step S108: No).

When the predetermined time has elapsed from the engine stop of the vehicle 10 (Step S108: Yes), the charging instruction unit 136 issues a charging start instruction, and the power receiving coil 11 receives power from the power feeding coil 21 and starts charging of the electrical storage device 13 (Step S109). Upon finishing charging a predetermined amount of power, the charging instruction unit 136 issues a charging end instruction, and charging ends (Step S110).

By the above-described flow, the parking assist processing executed by the parking assist device 110 of the first embodiment ends.

There has been known a technology of parking a vehicle at a predetermined position by assist of a parking assist device when using a parking area for a contactless charging system. Nevertheless, a method of determining a parking position of the vehicle has not been identified yet in a case where a power feeding coil of a parking area and a power receiving coil of a vehicle are different in the coil types.

According to the parking assist device 110 of the first embodiment, in a case where the power feeding coil 21 is a CR-type coil, the route determination unit 133 calculates a route in such a manner that a coil, namely, the first coil 11a in the above-described example, whose center position is closer to the center position of the vehicle 10, out of the center position of the first coil 11a and the center position of the second coil 11b of the power receiving coil 11, is positioned at a facing position to the power feeding coil 21.

As described above, charging efficiency becomes the maximum or a value close to the maximum by that, either the first coil 11a or the second coil 11b of the power receiving coil 11 is positioned at a facing position to the power feeding coil 21. Thus, charging efficiency can be enhanced by that the first coil 11a and the power feeding coil 21 are positioned at the facing position.

By the way, during transmission and reception of power, a magnetic field is generated from the power feeding coil 21 and a coil which is positioned at a facing position to the power feeding coil 21 and thus becomes a power receiving target. Then, part of the generated magnetic field is shielded by a vehicle body. Thus, when the power receiving target coil exists at a position closer to the center of the vehicle 10 in the front-back direction, a distance between an end of the vehicle 10 and the power receiving target coil and the power feeding coil 21 being a generation source of a magnetic field becomes longer, so that a magnetic field leaking to the periphery of the vehicle 10 is weakened. In other words, in a case where the power receiving target coil exists at a position close to the center of the vehicle 10 in the front-back direction, as compared with a case where the power receiving target coil exists at a distant position, a magnetic field is shielded more by the vehicle body of the vehicle 10. With this configuration, the influence of a leakage magnetic flux on a human or an animal existing near the vehicle 10 can be suppressed.

In the case of the above-described example, the first coil 11a being a power receiving target is disposed closer to the center side of the vehicle 10 than the second coil 11b. Accordingly, as compared with a case where the second coil 11b serves as a power receiving target, a leakage magnetic field to the periphery of the vehicle 10 can be suppressed.

As described above, the parking assist device 110 of the first embodiment can perform appropriate alignment in a case where the type of the power receiving coil 11 and the type of the power feeding coil 21 are different from each other.

### Modification Example

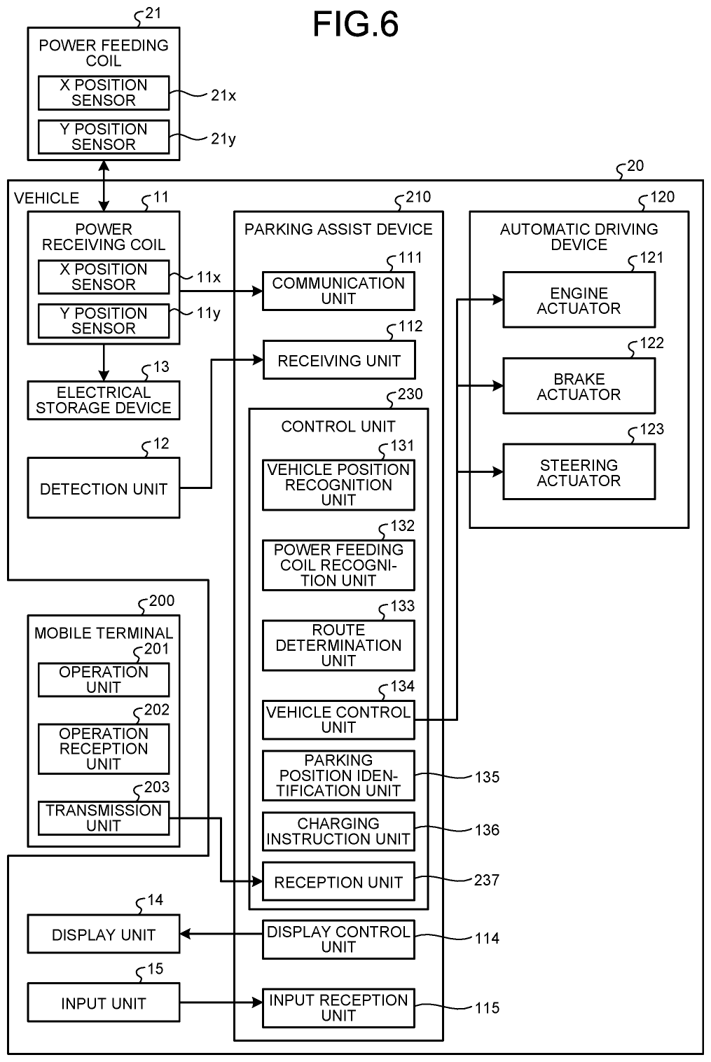

Next, an example of a parking assist device 210 of a modification example of the first embodiment will be described with referring to FIG. 6. The parking assist device 210 of the modification example differs from the above-described first embodiment in that, parking assist is performed in accordance with an instruction from a mobile terminal 200 owned by a driver or the like. Hereinafter, configurations similar to those of the first embodiment are assigned the same reference numerals, and the description thereof will be omitted.

FIG. 6 is a block diagram illustrating an example of a configuration of a vehicle 20 and the parking assist device 210 according to a modification example of the first embodiment. The vehicle 20 of the modification example is configured as a vehicle that can perform remote parking using parking assist. The remote parking refers to operation that a user remotely issues an execution instruction of automatic parking to a vehicle by using a mobile terminal, and the vehicle executes automatic parking on the basis of the instruction from the mobile terminal. For example, when the user carries a mobile terminal as a key of the vehicle and operates a parking button of the mobile terminal, an instruction signal for issuing a parking or get-out instruction is transmitted from the mobile terminal to the vehicle. In response to receiving an instruction indicated by the instruction signal, the vehicle performs a parking or get-out operation.

As illustrated in FIG. 6, the mobile terminal 200 is a terminal owned by a driver or the like who is an owner of the vehicle 20 and includes an operation unit 201, an operation reception unit 202, and a transmission unit 203. The mobile terminal 200 may be a mobile phone such as a smartphone, a tablet terminal, and the like. By installing a parking assist program onto the mobile terminal 200, the owner of the vehicle 20 can implement each of the above-described functional configurations on the mobile terminal 200.

The operation unit 201 is a parking button or the like that is displayed on a display unit of the mobile terminal 200. A driver can issue a parking instruction to the vehicle 20 by, for example, pressing a parking button on a picture. Accordingly, the parking button serves as an execution button for causing the vehicle 20 to start parking assist processing.

The operation reception unit 202 receives an input operation from the operation unit 201.

The transmission unit 203 transmits, to the parking assist device 210 of the vehicle 20, an instruction from a driver or the like, which has been input from the operation unit 201 and has been received by the operation reception unit 202.

The vehicle 20 includes a power receiving coil 11, detection units 12, an electrical storage device 13, an automatic driving device 120, and the parking assist device 210. The parking assist device 210 includes a communication unit 111, a receiving unit 112, a display control unit 114, an input reception unit 115, and a control unit 230. The control unit 230 includes a reception unit 237 in addition to the configurations included in the control unit 130 of the above-described first embodiment.

The reception unit 237 receives various instructions to the vehicle 20, which have been transmitted from the mobile terminal 200. For example, when the reception unit 237 receives a parking instruction, various configurations of the control unit 230 execute processing related to parking assist.

According to the parking assist device 210 of the modification example, various types of processing related to parking assist are executed upon receiving an instruction from the mobile terminal 200. With this configuration, when the mobile terminal 200 operated by a driver or the like exists at a distance at which communication can be performed with the vehicle 20, even when the driver or the like does not ride on the vehicle 20, the vehicle 20 can be automatically parked at a predetermined position. After that, the driver or the like can promptly leave the vicinity of the vehicle 20, and immediately start charging.

Heretofore, the description has been given of an example of parking the vehicle 10 or 20 into a parking area for a contactless charging system by automatic parking or remote parking in the vehicle 10 or 20 including an automatic parking function provided by the parking assist devices 110 or 210. The above-described alignment method used in a case where power is supplied and received between coils of different types can also be applied to another example. As another example, a parking area for a contactless charging system sometimes includes an automatic valet parking system.

In the automatic valet parking system, a parking area for a contactless charging system is provided with a server, and the server stores information of routes from a predetermined position in the parking area to each parking space. An acquisition unit of an automatic parking vehicle acquires the route information from the server, and a vehicle control unit performs control for automatic parking on the basis of the route information. At this time, the automatic parking vehicle transmits, to the server, position information of a coil whose center position closer to a center position of the vehicle in the front-back direction out of two coils in a power receiving coil, as position information of an alignment target coil.

### Second Embodiment

Hereinafter, a second embodiment will be described in detail with reference to the drawings. The second embodiment differs from the above-described first embodiment in that, an automatic parking function is parking control of executing semiautomatic parking assist that performs partial automatic control. Hereinafter, configurations similar to those of the first embodiment are assigned the same reference numerals, and the description thereof will be omitted.

### Configuration Example of Vehicle

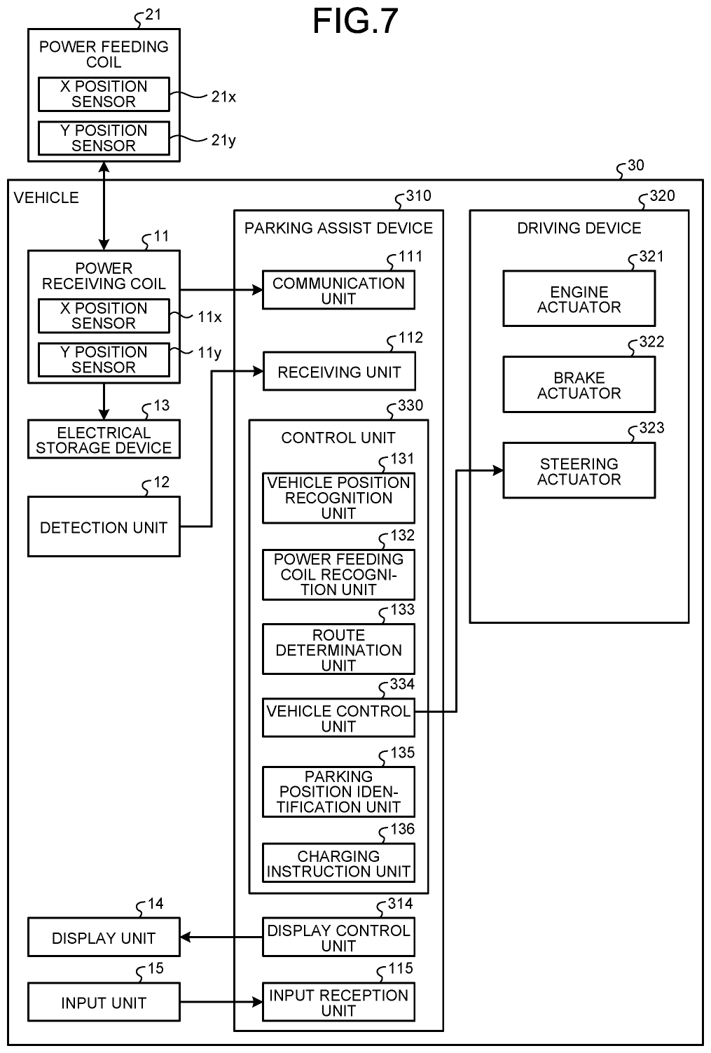

FIG. 7 is a block diagram illustrating an example of a configuration of a vehicle 30 according to the second embodiment. The vehicle 30 is configured as a vehicle in which, a parking assist device 310 automatically controls steering of the vehicle 30 on the basis of route information, and a driver operates an accelerator and a brake in accordance with an instruction from the parking assist device 310.

As illustrated in FIG. 7, the vehicle 30 of the second embodiment includes a power receiving coil 11, detection units 12, an electrical storage device 13, a display unit 14, an input unit 15, the parking assist device 310, and a driving device 320.

The parking assist device 310 includes a communication unit 111, a receiving unit 112, a display control unit 314, an input reception unit 115, and a control unit 330. The control unit 330 includes a vehicle control unit 334 in place of the vehicle control unit 134 included in the control unit 130 of the above-described first embodiment.

By controlling a steering actuator 323 on the basis of a parking route calculated by the route determination unit 133, the vehicle control unit 334 automatically parks the vehicle 30 at a predetermined position while receiving operations on the accelerator and the brake by the driver. In the vehicle control unit 334 of the second embodiment, control of parking the vehicle 30 corresponds to a configuration of controlling steering of the vehicle 30 on the basis of route information.

The display control unit 314 controls the display unit 14 to display a picture indicating a route for parking that has been calculated by the route determination unit 133 of the control unit 330. The driver parks the vehicle 30 at a predetermined position by operating the accelerator and the brake of the vehicle 30 on the basis of route information displayed on the display unit 14.

The driving device 320 includes an engine actuator 321, a brake actuator 322, and the steering actuator 323.

Even in the parking assist processing, the engine actuator 321 adjusts supply amounts of fuel and air to be supplied to an engine on the basis of operation of an accelerator pedal by the driver, similarly to a normal running state. Even in the parking assist processing, the brake actuator 322 adjusts braking force of wheels included in the vehicle 30 on the basis of operation of a brake pedal that is performed by the driver, similarly to a normal running state. At least in the parking assist processing, the steering actuator 323 adjusts a steering angle of the vehicle 30 on the basis of an output of the vehicle control unit 334.

### Example of Parking Assist Processing

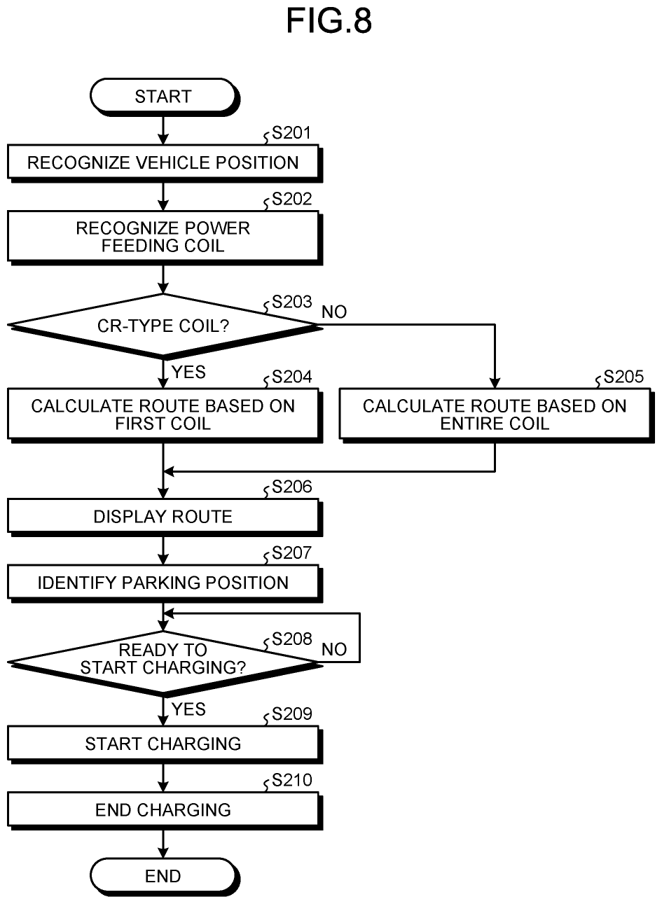

Next, an example of parking assist processing to be executed by the parking assist device 310 of the second embodiment will be described with referring to FIG. 8. FIG. 8 is a flowchart illustrating an example of a procedure of parking assist processing to be executed by the parking assist device 310 according to the second embodiment. Processing in Steps S201 to S205 illustrated in FIG. 8 is the same processing as the processing in Steps S101 to S105 illustrated in FIG. 5 of the above-described first embodiment.

When the route determination unit 133 calculates a route for parking (Step S204, S205), the display control unit 314 displays a picture indicating the route on the display unit 14 (Step S206). The driver operates the accelerator and the brake of the vehicle 30 in accordance with an instruction shown in the picture displayed on the display unit 14 to park the vehicle 30 at a predetermined position within the parking region 22 provided with the power feeding coil 21 while receiving control of the steering actuator 323 by the vehicle control unit 334.

Subsequent processing in Steps S207 to S210 is the same processing as the processing in Steps S107 to S110 illustrated in FIG. 5 of the above-described first embodiment.

Specifically, the parking position identification unit 135 identifies a parking position where the driver has parked the vehicle 30 (Step S207). The charging instruction unit 136 determines whether or not charging can be performed (Step S208). Then, the power receiving coil 11 performs charging of the electrical storage device 13 (Steps S209 to S210).

By the above, the parking assist processing executed by the parking assist device 310 of the second embodiment ends.

Note that, in the configuration of the above-described second embodiment, the vehicle 30 is parked at a predetermined position by the driver operating the accelerator pedal and the brake pedal while the vehicle control unit 334 automatically controlling the steering actuator 323 in accordance with a route calculated by the route determination unit 133, but the configuration is not limited to this example. The vehicle may be parked at a predetermined position by the driver operating the accelerator pedal and the brake pedal while performing steering in accordance with a route calculated by the route determination unit.

In addition, in the above-described first and second embodiments and the modification example, the vehicle position recognition unit 131 recognizes positions of the parking region 22 and the power feeding coil 21 on the basis of detection signals from the detection units 12, but the configuration is not limited to this example. The vehicle position recognition unit may acquire position information of at least either of the parking region and the power feeding coil from a management system of a parking area.

In addition, in the above-described first and second embodiments and the modification example, the power feeding coil recognition unit 132 recognizes the type of the power feeding coil 21 on the basis of detection signals from the detection units 12, but the configuration is not limited to this example. The power feeding coil recognition unit may acquire information regarding the type of the power feeding coil from a management system of a parking area.

In addition, in the above-described first and second embodiments and the modification example, the vehicle 10, 20, or 30 is parked in accordance with a route determined by the route determination unit 133 before the vehicle 10, 20, or 30 starts operation of parking, but a method of parking assist is not limited to this example. In a case where a trajectory of a vehicle that targets on a parking region deviates from a route, a route determination unit may reset a route to a parking position from a position of the vehicle at the moment. An automatic driving device, a driving device, or a driver or the like can guide a vehicle to an appropriate parking position while appropriately correcting an orbit of the vehicle. The deviation of the vehicle from the route can be identified by acquiring a detection signal from a detection unit on a moment-to-moment basis, and also acquiring a signal transmitted and received between a power receiving coil and a power feeding coil. A management system of a parking area may include a mechanism of detecting a positional shift between the power receiving coil and the power feeding coil, and raising an alarm.

Several embodiments of the present disclosure have been described, whereas these embodiments are presented as examples, and are not intended to limit the scope of the invention. These embodiments can be implemented in other various forms, and various omissions, replacements, and changes can be made without departing from the gist of the invention. These embodiments and modification examples thereof are included in the scope and gist of the invention, and are similarly included in the scope of an equivalent of the invention described in the appended claims.

What is claimed is:

1. A parking assist device used for a vehicle on which a power receiving coil including a first coil and a second coil is mounted, the parking assist device comprising:
a hardware processor connected to a memory and configured to function as:
an acquisition unit serving to acquire route information for parking the vehicle at a facing position where a power feeding coil installed in a parking region and the power receiving coil included in the vehicle face each other; and
a vehicle control unit serving to perform control of parking the vehicle on the basis of the route information, wherein
the power receiving coil is mounted on the vehicle in such a manner that a distance between a center position of the first coil and a center position of the vehicle in a vehicle length direction becomes shorter than a distance between a center position of the second coil and the center position of the vehicle in the vehicle length direction, and
the facing position is a position where the power feeding coil and the first coil of the power receiving coil face each other.

2. The parking assist device according to claim 1, wherein the first coil and the second coil are adjacent to each other on a same plane and are formed from a single wire.

3. The parking assist device according to claim 1, wherein the hardware processor is configured to further function as a power feeding coil recognition unit serving to acquire information regarding the power feeding coil and recognize a type of the power feeding coil.

4. The parking assist device according to claim 1, wherein the acquisition unit serves to calculate a route for parking the vehicle in the parking region, the route being calculated on the basis of a position of the vehicle relative to the parking region and a type of the power feeding coil.

5. The parking assist device according to claim 4, wherein the hardware processor is configured to further function as a vehicle position recognition unit serving to recognize a position of the vehicle relative to the parking region.

6. The parking assist device according to claim 1, wherein the hardware processor is configured to further function as a display control unit serving to cause a display device to display a picture showing the route information to a driver.

7. The parking assist device according to claim 1, wherein the facing position is a position where a center position of the power feeding coil and the center position of the first coil face each other.

8. The parking assist device according to claim 1, wherein
adjacent sides are included, on which the first coil and the second coil are adjacent to each other, and
the facing position is a position where a center position of the power feeding coil and a position deviating from the center position of the first coil toward the adjacent sides face each other.

9. A parking assist method executed on a vehicle on which a power receiving coil including a first coil and a second coil is mounted, the parking assist method comprising:
acquiring route information for parking the vehicle at a facing position where a power feeding coil installed in a parking region and the power receiving coil included in the vehicle face each other; and
performing control of parking the vehicle on the basis of the route information, wherein
the power receiving coil is mounted on the vehicle in such a manner that a distance between a center position of the first coil and a center position of the vehicle in a vehicle length direction becomes shorter than a distance between a center position of the second coil and the center position of the vehicle in the vehicle length direction, and
the acquiring of route information is performed by acquiring route information for parking the vehicle at the facing position where the power feeding coil and the first coil of the power receiving coil face each other.

10. A non-transitory computer-readable recording medium on which a program executable by a computer is recorded, the computer performing parking assist on a vehicle on which a power receiving coil including a first coil and a second coil is mounted, the program instructing the computer to execute:
processing of acquiring route information for parking the vehicle at a facing position where a power feeding coil installed in a parking region and the power receiving coil included in the vehicle face each other; and
processing of performing control of parking the vehicle on the basis of the route information, wherein
the power receiving coil is mounted on the vehicle in such a manner that a distance between a center position of the first coil and a center position of the vehicle in a vehicle length direction becomes shorter than a distance between a center position of the second coil and the center position of the vehicle in the vehicle length direction, and
the processing of acquiring route information is performed by acquiring route information for parking the vehicle at the facing position where the power feeding coil and the first coil of the power receiving coil face each other.
